(19) United States
(12) Patent Application Publication
(10) Pub. No.: US 2022/0116781 A1
(43) Pub. Date: Apr. 14, 2022

(54) APPARATUS, SYSTEM, AND METHOD OF COMMUNICATION OVER A LICENSED WIRELESS COMMUNICATION CHANNEL

(71) Applicant: Intel Corporation, Santa Clara, CA (US)

(72) Inventors: Laurent Cariou, Milizac (FR); Thomas J. Kenney, Portland, OR (US); Robert Stacey, Portland, OR (US)

(73) Assignee: Intel Corporation, Santa Clara, CA (US)

(21) Appl. No.: 17/559,920

(22) Filed: Dec. 22, 2021

(51) Int. Cl. H04W 12/08; H04W 76/15

(52) U.S. Cl. CPC H04W 12/08; H04W 76/15

(57) ABSTRACT

For example, an apparatus may be configured to cause an Access Point (AP) to generate an information element including licensed-channel information corresponding to a licensed sub 10 Gigahertz (GHz) (sub-10 GHz) wireless communication channel, which is restricted to private access, the licensed-channel information configured to indicate a central frequency of the licensed sub-10 GHz wireless communication channel, and a bandwidth of the licensed sub-10 GHz wireless communication channel; and to transmit a frame over an unlicensed sub-10 GHz wireless communication channel, which is not restricted to the private access, the unlicensed sub-10 GHz wireless communication channel different from the licensed sub-10 GHz wireless communication channel, the frame including the information element including the licensed-channel information.

### TECHNICAL FIELD

Aspects described herein generally relate to wireless communication utilizing a licensed sub 10 Gigahertz (GHz) (sub-10 GHz) wireless communication channel.

### BACKGROUND

Devices in a wireless communication system may be configured to communicate according to communication protocols, which may utilize non-licensed wireless communication channels.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic flow-chart illustration of a method of wireless communication over a licensed sub-10 GHz wireless communication channel, in accordance with some demonstrative aspects.

FIG. 5 is a schematic flow-chart illustration of a method of wireless communication over a licensed sub-10 GHz wireless communication channel, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D1.2 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), September 2021)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

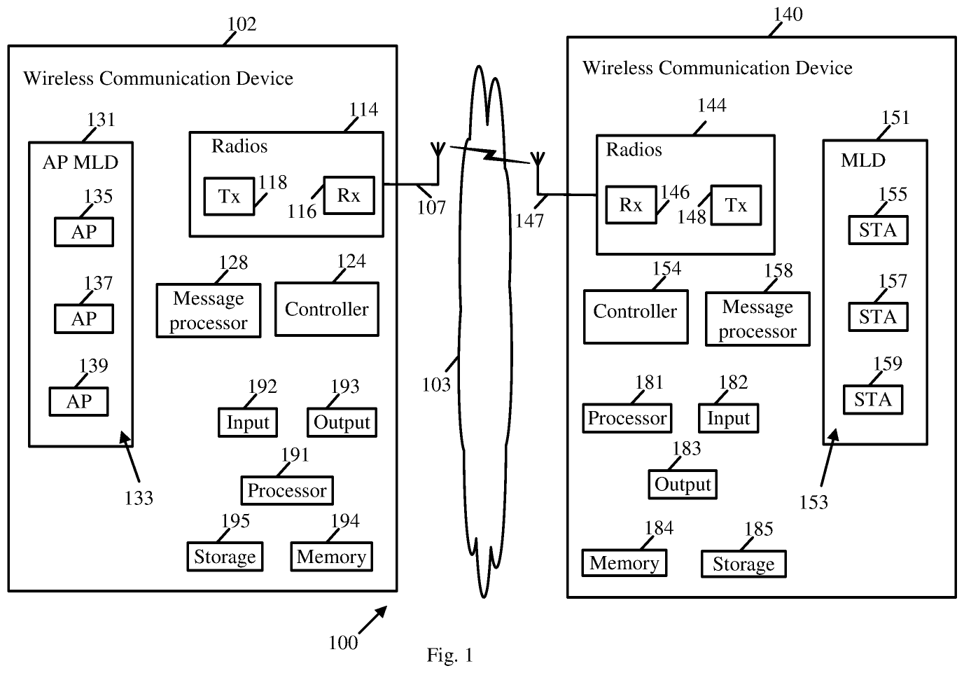

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternative include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include on or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In other aspects, devices 102 and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to cause, trigger, instruct and/or control device 102 to operate as, perform a role of, and/or perform one or more operations and/or functionalities of, an AP MLD 131 including a plurality of AP STAs 133, e.g., including an AP STA 135, an AP STA 137 and/or an AP STA 139. In some aspects, as shown in FIG. 1, AP MLD 131 may include three AP STAs. In other aspects, AP MLD 131 may include any other number of AP STAs.

In one example, AP STA 135, AP STA 137 and/or AP STA 139 may operate as, perform a role of, and/or perform one or more operations and/or functionalities of, an EHT AP STA. In other aspects, AP STA 135, AP STA 137 and/or AP STA 139 may perform any other additional or alternative functionality.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, the radios 114 utilized by APs 133 may be implemented as separate radios. In other aspects, the radios 114 utilized by APs 133 may be implemented by one or more shared and/or common radios and/or radio components.

In other aspects controller 124 may be configured to cause, trigger, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to cause, trigger, instruct and/or control device 140 to operate as, perform a role of, and/or perform one or more operations and/or functionalities of, an MLD 151 including a plurality of STAs 153, e.g., including a STA 155, a STA 157 and/or a STA 159. In some aspects, as shown in FIG. 1, MLD 151 may include three STAs. In other aspects, MLD 151 may include any other number of STAs.

In one example, STA 155, STA 157 and/or STA 159 may operate as, perform a role of, and/or perform one or more operations and/or functionalities of, an EHT STA. In other aspects, STA 155, STA 157 and/or STA 159 may perform any other additional or alternative functionality.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to cause, trigger, instruct and/or control MLD 151 to operate as, perform a role of, and/or perform one or more operations and/or functionalities of, a non-AP MLD. For example, STA 155, STA 157 and/or STA 159 may operate as, perform a role of, and/or perform one or more operations and/or functionalities of, a non-AP EHT STA.

In some demonstrative aspects, controller 154 may be configured to cause, trigger, instruct and/or control MLD 151 to operate as, perform a role of, and/or perform one or more operations and/or functionalities of, an AP MLD. For example, STA 155, STA 157 and/or STA 159 may operate as, perform a role of, and/or perform one or more operations and/or functionalities of, an AP EHT STA.

In other aspects controller 154 may be configured to cause, trigger, instruct and/or control device 140 to operate as, perform a role of, and/or perform one or more operations and/or functionalities of, any other additional or alternative entity and/or STA, e.g., a single STA, multiple STAs, and/or a non-MLD entity.

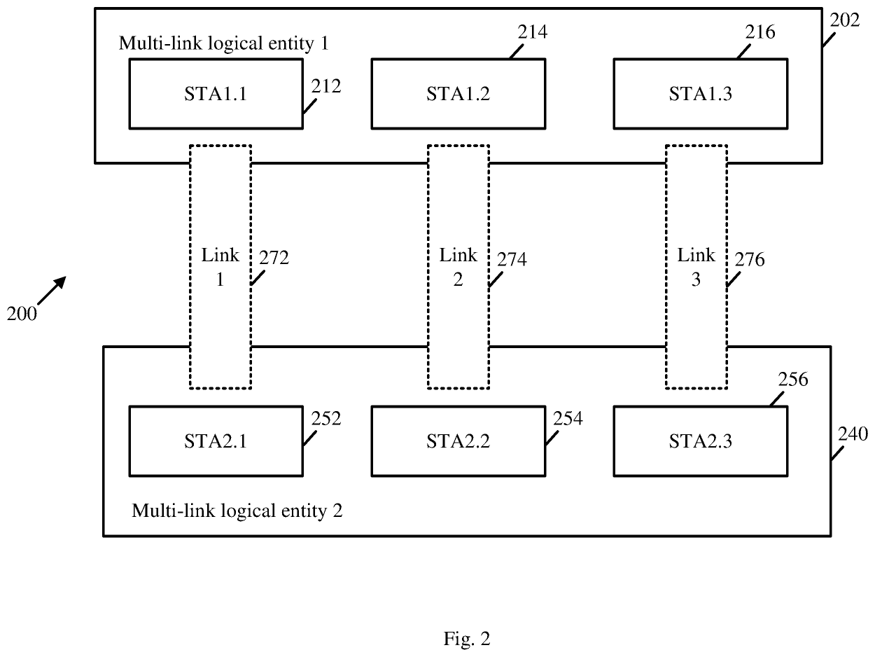

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, and a STA 216. In one example, AP MLD 131 (FIG. 1) may perform one or more operations, one or more functionalities, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, and a STA 256. In one example, MLD 151 (FIG. 1) may perform one or more operations, one or more functionalities, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, and/or a link 276 between STA 216 and STA 256.

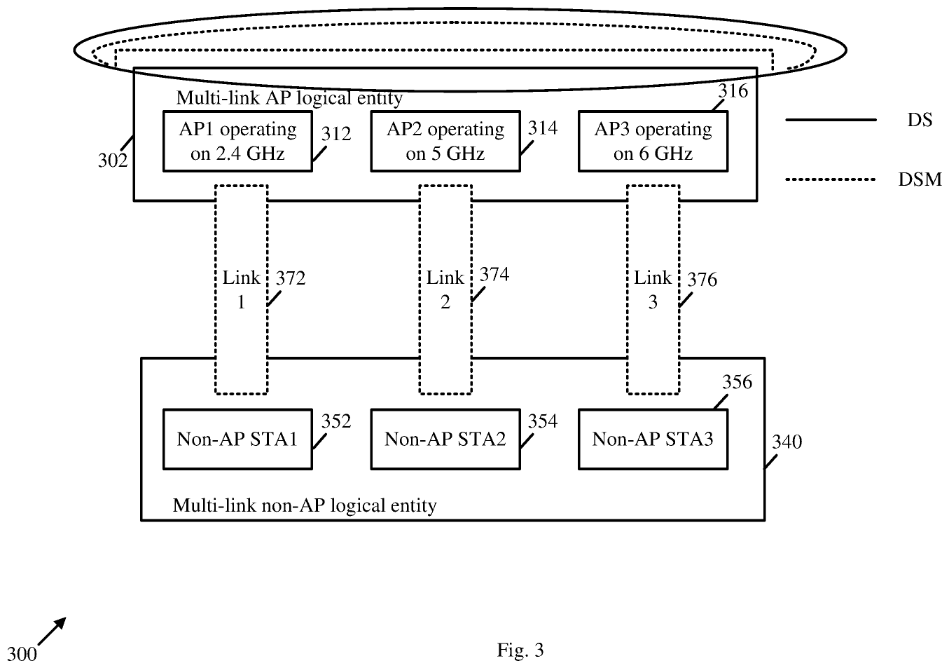

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, and an AP STA 316. In one example, AP MLD 131 (FIG. 1) may perform one or more operations, one or more functionalities, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, and a non-AP STA 356. In one example, MLD 151 (FIG. 1) may perform one or more operations, one or more functionalities, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, and/or a link 376 between AP STA 316 and non-AP STA 356.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, and/or AP STA 316 may be configured to communicate over a 6 Ghz frequency band. In other aspects, AP STA 312, AP STA 314, and/or AP STA 316, may be configured to communicate over any other additional or alternative wireless communication frequency bands.

Referring back to FIG. 1, in some demonstrative aspects, devices 102 and/or 140 may be configured to communicate over one or more licensed wireless communication channels, which may be restricted to private access, e.g., as described below.

In some demonstrative aspects, devices 102 and/or 140 may be configured to utilize a licensed wireless communication channel for communication over a private network, e.g., as described below.

In some demonstrative aspects, one or more licensed wireless communication channels may be defined in a licensed wireless communication band, which may be provided for private use, e.g., with a local license.

For example, the local license may include a license, which may be owned only in a particular location, for example, in the premises of an enterprise, e.g., a smart factory, any other industrial use, and/or any other private and/or restricted use.

In one example, private networks may implement licensed bands according to a 3GPP technology, e.g., even if regulation doesn't mandate the use of any particular technology in the licensed bands.

In some demonstrative aspects, devices 102 and/or 140 may be configured to support a technical solution for operation over private networks utilizing one or more licensed wireless communication bands, for example, according to a local license, which may include, for example, a license for Smart Factories or Industrial use, a light license, and/or any other additional or alternative type of license.

In some demonstrative aspects, for example, in some use cases, implementations, scenarios, and/or deployments, employing a private network over a licensed wireless communication band may provide a technical solution to ensure no pollution, or reduced pollution, of the licensed band by other devices, which may be a limiting factor in unlicensed bands, e.g., in terms of latency.

In some demonstrative aspects, for example, in some use cases, implementations, scenarios, and/or deployments, employing a private network over a licensed wireless communication band may provide a technical solution which may be well suited, e.g., efficient, for low latency applications/Time Sensitive Networking (TSN) deployments.

In some use cases, implementations, scenarios, and/or deployments, 3GPP technology may be likely proposed in private network models. For example, the 3GPP technology may represent a possible threat to a Wi-Fi network in the enterprise, for example, as triggering deployments of 3GPP technologies can easily spill into unlicensed bands.

In some demonstrative aspects, for example, in some use cases, implementations, scenarios, and/or deployments, employing a private network over a licensed wireless communication band may provide a technical solution to support a Wi-Fi network with substantially no pollution and/or with full control of the airtime. Accordingly, this solution may support a hard-to-beat performance, e.g., for latency Public Key Infrastructures (PKIs), e.g., TSN deployments.

In some demonstrative aspects, devices 102 and/or 140 may be configured to operate over one or more sub-10 GHz wireless communication channels in a sub-10 GHz frequency band, e.g., as described below.

In some demonstrative aspects, devices 102 and/or 140 may be configured to operate over one or more wireless communication channel widths, for example, 20 MHz channels, 40 MHz channels, 80 MHz channels, 160 MHz channels, 320 MHz channels, in one or more frequency bands, for example, a 2.4 GHz band, and/or a band between 5 GHz and 7 GHz, e.g., as described below.

In some demonstrative aspects, devices 102 and/or 140 may be configured to operate, e.g., efficiently, on any other additional or alternative channel bandwidth, e.g., a channel bandwidth narrower than 20 MHz and/or a channel bandwidth wider than 320 Mhz.

In some demonstrative aspects, devices 102 and/or 140 may be configured to operate, e.g., efficiently, on any other additional or alternative channel bandwidth in any other sub-10 Ghz frequency band.

In some demonstrative aspects, devices 102 and/or 140 may be configured to implement a communication scheme to operate, e.g., efficiently, over one or more licensed wireless communication channels, for example, in accordance with an IEEE 802.11be Specification, e.g., as described below.

In some demonstrative aspects, device 102 may be configured to operate at least one first AP over a licensed sub 10 Gigahertz (GHz) (sub-10 GHz) wireless communication channel, and at least one second AP over an unlicensed sub-10 GHz wireless communication channel, e.g., as described below.

In some demonstrative aspects, device 140 may be configured to operate at least one STA over the licensed sub-10 GHz wireless communication channel and/or the unlicensed sub-10 GHz wireless communication channel, e.g., as described below.

In some demonstrative aspects, devices 102 and/or 140 may be configured to support a technical solution to utilize communications over an unlicensed sub-10 Ghz frequency channel, for example, to assist one or more operations to be performed by devices 102 and/or 140 over a licensed sub-10 Ghz frequency channel, e.g., as described below.

In some demonstrative aspects, device 102 and/or device 140 may be configured to utilize communications over the unlicensed sub-10 Ghz frequency channel, for example, to communicate licensed-channel information, which may be configured to support one or more operations and/or functionalities over the licensed sub-10 Ghz frequency channel, e.g., as described below.

In some demonstrative aspects, device 102 and/or device 140 may be configured to utilize communications over the unlicensed sub-10 Ghz frequency channel, for example, to assist in discovery and/or association over the licensed sub-10 Ghz frequency channel, e.g., as described below.

In other aspects, device 102 and/or device 140 may be configured to utilize communications over the unlicensed sub-10 Ghz frequency channel, for example, to assist in any other additional or alternative operations over the licensed sub-10 Ghz frequency channel.

In some demonstrative aspects, devices 102 and/or 140 may be configured to implement an unlicensed sub-10 Ghz frequency channel assistance mechanism, which may be configured to assist a non-AP STA implemented by device 140 to discover and/or associate with an AP implemented by device 102 over the licensed sub-10 Ghz frequency channel, for example, based on the assistance of licensed channel information communicated over the unlicensed sub-10 Ghz frequency channel, e.g., as described below.

In some demonstrative aspects, controller 124 may be configured to operate a first AP implemented by device 102, e.g., AP 135, to communicate over the unlicensed sub-10 Ghz frequency channel, and/or to operate a second AP implemented by device 102, e.g., AP 137, to communicate over the licensed sub-10 Ghz frequency channel.

In some demonstrative aspects, controller 124 may be configured to cause an AP implemented by device 102, e.g., AP 135, to generate an information element including licensed-channel information corresponding to a licensed sub-10 GHz wireless communication channel, which is restricted to private access, e.g., as described below.

In some demonstrative aspects, the licensed-channel information may be configured to indicate a central frequency of the licensed sub-10 GHz wireless communication channel, and a bandwidth of the licensed sub-10 GHz wireless communication channel, e.g., as described below.

In some demonstrative aspects, the licensed-channel information may be configured to indicate any other additional or alternative information corresponding to the licensed sub-10 GHz wireless communication channel.

In some demonstrative aspects, controller 124 may be configured to cause the AP implemented by device 102, e.g., AP 135, to transmit a frame including the information element including the licensed-channel information, for example, over an unlicensed sub-10 GHz wireless communication channel, e.g., as described below.

In some demonstrative aspects, the unlicensed sub-10 GHz wireless communication channel may include an unlicensed channel which is not restricted to the private access, e.g., as described below.

In some demonstrative aspects, the unlicensed sub-10 GHz wireless communication channel may be different from the licensed sub-10 GHz wireless communication channel, e.g., as described below.

In some demonstrative aspects, the unlicensed sub-10 GHz wireless communication channel may include an unlicensed channel in a 2.4 GHz wireless communication frequency band, an unlicensed channel in a 5 GHz wireless communication frequency band, or an unlicensed channel in a 6 GHz wireless communication frequency band, e.g., as described below.

In other demonstrative aspects, the unlicensed sub-10 GHz wireless communication channel may include an unlicensed channel in any other additional or alternative sub-10 GHz wireless communication frequency band.

In some demonstrative aspects, controller 124 may be configured to cause radio 114 to transmit the frame over the unlicensed sub-10 GHz wireless communication channel, e.g., as described below.

In some demonstrative aspects, the frame may include a beacon, e.g., as described below.

In some demonstrative aspects, the frame may include a probe response, e.g., as described below.

In other aspects, the frame may include any other additional or alternative type of frame.

In some demonstrative aspects, the frame may include a neighbor report element including the information element including the licensed-channel information, e.g., as described below.

In other aspects, the information element including the licensed-channel information may be included as part of any other element and/or field of the frame.

In some demonstrative aspects, the licensed-channel information may be configured to indicate the central frequency of the licensed sub-10 GHz wireless communication channel, for example, based on a sum of a starting frequency and a product of an integer channel number by 1 Megahertz (MHz), e.g., as described below.

In some demonstrative aspects, the licensed-channel information may be configured to indicate the bandwidth of the licensed sub-10 GHz wireless communication channel, for example, based on an integer multiple of a basic channel frequency, e.g., as described below.

In some demonstrative aspects, the basic channel frequency may include a frequency of 5 MHz, 10 MHz, 20 MHz, or 100 MHz, e.g., as described below.

In other aspects, the basic channel frequency may include any other additional or alternative frequency.

In other aspects, the licensed-channel information may utilize any other mechanism to indicate the central frequency of the licensed sub-10 GHz wireless communication channel and/or the bandwidth of the licensed sub-10 GHz wireless communication channel.

In some demonstrative aspects, the licensed-channel information may be configured to indicate one or more transmit power limitations for transmission over the licensed sub-10 GHz wireless communication channel, e.g., as described below.

In some demonstrative aspects, the licensed-channel information may be configured to indicate one or more Physical layer (PHY) processing parameters for processing communication over the licensed sub-10 GHz wireless communication channel, e.g., as described below.

In some demonstrative aspects, the licensed-channel information may be configured to indicate any other additional pr alternative information corresponding to the licensed sub-10 GHz wireless communication channel and/or corresponding to communications over the licensed sub-10 GHz wireless communication channel.

In some demonstrative aspects, the AP implemented by device 102 may include a first AP of a plurality of APs of an AP MLD, and the licensed sub-10 GHz wireless communication channel may include a wireless communication channel utilized by a second AP of the plurality of APs of the AP MLD, e.g., as described below.

For example, the AP implemented by device 102 may include AP 135 of plurality of APs 133 of AP MLD 131, and the licensed sub-10 GHz wireless communication channel may include a wireless communication channel utilized by AP 137.

In some demonstrative aspects, controller 124 may be configured to cause the second AP implemented by device 102, e.g., AP 137, to communicate an other frame between the second AP and a non-AP STA over the licensed sub-10 GHz wireless communication channel, e.g., as described below.

For example, controller 124 may be configured to cause AP 137 to communicate an other frame with STA 155 over the licensed sub-10 GHz wireless communication channel.

In some demonstrative aspects, controller 154 may be configured to cause a non-AP STA implemented by device 140, e.g., STA 155, to process an information element in a first frame from a first AP, e.g., as described below.

In some demonstrative aspects, the first frame may be received by the non-AP STA over an unlicensed sub-10 GHz wireless communication channel, which is not restricted to private access, e.g., as described below.

For example, the frame may be received by the non-AP STA implemented by device 140, e.g., STA 155, for example, from the AP implemented by device 102.

In some demonstrative aspects, the information element may include licensed-channel information corresponding to a licensed sub-10 GHz wireless communication channel, which is restricted to the private access, e.g., as described below.

In some demonstrative aspects, controller 154 may be configured to operate radio 144 to receive the first frame over the unlicensed sub-10 GHz wireless communication channel, e.g., as described below.

For example, STA 155 may be configured to process the information element in the first frame, which may be received by STA 155, e.g., from AP 135, over the unlicensed sub-10 GHz wireless communication channel.

In some demonstrative aspects, controller 154 may be configured to cause the non-AP STA implemented by device 140, e.g., STA 155, to identify, for example, based on the licensed-channel information, a central frequency of the licensed sub-10 GHz wireless communication channel, and/or a bandwidth of the licensed sub-10 GHz wireless communication channel, e.g., as described below.

In some demonstrative aspects, controller 154 may be configured to cause the non-AP STA implemented by device 140, e.g., STA 155, to communicate a second frame between the non-AP STA and a second AP over the licensed sub-10 GHz wireless communication channel, e.g., as described below.

For example, controller 154 may be configured to cause STA 155 to communicate the second frame between STA 155 and AP 137 over the licensed sub-10 GHz wireless communication channel, for example, based on the licensed-channel information in the first frame received from AP 135 over the unlicensed sub-10 GHz wireless communication channel.

In some demonstrative aspects, controller 154 may be configured to cause radio 144 to communicate the second frame over the licensed sub-10 GHz wireless communication channel, e.g., as described below.

In some demonstrative aspects, the first frame may include a neighbor report element including the information element including the licensed-channel information, e.g., as described below.

In some demonstrative aspects, the first frame may include a beacon.

In some demonstrative aspects, the first frame may include a probe response.

In other aspects, the first frame may include any other additional or alternative type of frame.

In some demonstrative aspects, the non-AP STA implemented by device 140 may include a non-AP MLD including a plurality of non-AP STAs. For example, the first frame may be received by a first non-AP STA of the plurality of non-AP STAs of the non-AP MLD, and the second frame may be communicated by a second non-AP STA of the plurality of non-AP STAs of the non-AP MLD, e.g., as described below.

For example, controller 154 may be configured to cause MLD 151 to process the first frame, which may be received by STA 155, and to communicate the second frame by STA 157.

In some demonstrative aspects, controller 154 may be configured to cause the non-AP STA implemented by device 140, e.g., STA 155, to determine the central frequency of the licensed sub-10 GHz wireless communication channel based on the licensed-channel information, for example, based on a sum of a starting frequency and a product of an integer channel number by 1 MHz, e.g., as described below.

In other aspects, device 140 may determine the central frequency of the licensed sub-10 GHz wireless communication channel based on any other additional or alternative mechanism.

In some demonstrative aspects, controller 154 may be configured to cause the non-AP STA implemented by device 140, e.g., STA 155, to determine the bandwidth of the licensed sub-10 GHz wireless communication channel based on the licensed-channel information, for example, based on an integer multiple of a basic channel frequency, e.g., as described below.

In other aspects, device 140 may determine the bandwidth of the licensed sub-10 GHz wireless communication channel based on any other additional or alternative mechanism.

In some demonstrative aspects, the basic channel frequency may include 5 MHz, 10 MHz, 20 MHz, or 100 MHz frequency.

In other aspects, the basic channel frequency may include any other additional or alternative frequency.

In some demonstrative aspects, controller 154 may be configured to cause the non-AP STA implemented by device 140, e.g., STA 155, to determine one or more transmit power limitations for transmission over the licensed sub-10 GHz wireless communication channel, for example, based on the licensed-channel information, e.g., as described below.

In some demonstrative aspects, controller 154 may be configured to cause the non-AP STA implemented by device 140, e.g., STA 155, to determine one or more Physical layer (PHY) processing parameters for processing communication over the licensed sub-10 GHz wireless communication channel, for example, based on the licensed-channel information, e.g., as described below.

In some demonstrative aspects, controller 154 may be configured to cause the non-AP STA implemented by device 140, e.g., STA 155, to determine any other additional or alternative information for processing communication over the licensed sub-10 GHz wireless communication channel, for example, based on the licensed-channel information.

In some demonstrative aspects, controller 154 may be configured to disable the non-AP STA implemented by device 140, e.g., STA 155, to transmit any probe frames over the licensed sub-10 GHz wireless communication channel, e.g., as described below.

In some demonstrative aspects, controller 154 may be configured to disable the non-AP STA implemented by device 140, e.g., STA 155, to access the sub-10 GHz wireless communication channel, for example, unless triggered by the second AP, e.g., AP 137, e.g., as described below.

In some demonstrative aspects, controller 154 may be configured to restrict the non-AP STA implemented by device 140, e.g., STA 155, to accessing the sub-10 GHz wireless communication channel, for example, for transmission only based on receipt of a trigger frame from the second AP, e.g., AP 137, over the licensed sub-10 GHz wireless communication channel, e.g., as described below.

In some demonstrative aspects, devices 102 and/or 140 may be configured to utilize a multi-band framework, e.g., in accordance with an IEEE 802.11be Specification, for example, to support operation in a plurality of different channels, e.g., in a frequency band between 1 and 10 GHz.

In some demonstrative aspects, devices 102 and/or 140 may be configured to implement a channel-definition mechanism to define and/or identify a wireless communication channel using one or more parameters which may be chosen, for example, to specify the channel that a Wi-Fi device, e.g., device 102 and/or device 140, may be able to operate on.

For example, the channel-definition mechanism may be configured to define parameters and/or channelization to be as generic as possible, to support channels and/or bands, which may be introduced in the future.

In some demonstrative aspects, devices 102 and/or 140 may be configured to operate on one or more channels, e.g., any channels, between a first frequency, e.g., 1 GHz, and a second frequency, e.g., 10 GHz.

In some demonstrative aspects, devices 102 and/or 140 may be configured to communicate over the unlicensed sub-10 GHz wireless communication channel one or more parameters to define a wireless communication channel, e.g., a licensed wireless communication channel, e.g., as described below.

In some demonstrative aspects, devices 102 and/or 140 may be configured to communicate over the unlicensed sub-10 GHz wireless communication channel one or more parameters to define a center frequency of a wireless communication channel, e.g., a licensed wireless communication channel. For example, the central frequency may be obtained through an operating class parameter and operating channels, for example, with an operating class/band starting frequency, e.g., 3 GHz, and a value determining how far the center frequency of the channel is from the operating class/band starting frequency.

In one example, the value determining how far the center frequency of the channel is from the operating class/band starting frequency may be defined as an integer that is multiplied by 5 MHz, e.g., in accordance with the IEEE 802.11be Specification.

In another example, the value determining how far the center frequency of the channel is from the operating class/band starting frequency may be defined as an integer that is multiplied by 1 MHz. According to this definition, there may be one channel center frequency defined every MHz.

In other aspects, the value determining how far the center frequency of the channel is from the operating class/band starting frequency may be defined as an integer that is multiplied by any other frequency value.

In some demonstrative aspects, the channel center frequency may be defined as a sum of an operating class/band starting frequency and a product of an integer channel number multiplied by 1 MHz, e.g., Channel Center frequency=operating class/band starting frequency+channel_number*1 MHz.

In other aspects, the channel center frequency may be defined in any other additional or alternative manner.

In some demonstrative aspects, devices 102 and/or 140 may be configured to signal over the unlicensed sub-10 GHz wireless communication channel information to define the channel center frequency of the licensed wireless communication channel, for example, using one or more operating class/channel numbers.

In other aspects, devices 102 and/or 140 may be configured to signal over the unlicensed sub-10 GHz wireless communication channel information to define the channel center frequency of the licensed wireless communication channel according to any other signaling mechanism.

In some demonstrative aspects, devices 102 and/or 140 may be configured to communicate over the unlicensed sub-10 GHz wireless communication channel one or more parameters to define a bandwidth of a wireless communication channel, e.g., a licensed wireless communication channel.

In some demonstrative aspects, the bandwidth of the licensed wireless communication channel may be determined, for example, based on a basic channel frequency.

In some demonstrative aspects, the basic channel frequency may be defined as 20 MHz, e.g., in accordance with the IEEE 802.11be Specification. For example, a basic channel frequency of 20 MHz may be a minimum bandwidth, for example, to detect/transmit basic frames from/to an AP.

In other aspects, the basic channel frequency may be defined to include any other frequency bandwidth, e.g., 5 MHz, 10 MHz, 20 MHz, 100 MHz, or any other frequency bandwidth.

For example, the bandwidth may not necessarily be obtained through channel bonding, e.g., as may be used for transmitting PPDUs on multiple channels.

In some demonstrative aspects, devices 102 and/or 140 may be configured to communicate over the unlicensed sub-10 GHz wireless communication channel one or more parameters to defined communications to be performed over the licensed wireless communication channel.

In some demonstrative aspects, devices 102 and/or 140 may be configured to communicate over the unlicensed sub-10 GHz wireless communication channel one or more parameters to define one or more power constraints/power limits for transmission over the licensed sub-10 GHz wireless communication channel.

In some demonstrative aspects, devices 102 and/or 140 may be configured to signal over the unlicensed sub-10 GHz wireless communication channel a maximum Equivalent Isotropic Radiated Power (EIRP), a maximum Power Spectral Density (PSD) EIRP, and/or any other additional or alternative parameters corresponding to power constraints/power limits for communication over the licensed sub-10 GHz wireless communication channel.

In some demonstrative aspects, devices 102 and/or 140 may be configured to communicate over the unlicensed sub-10 GHz wireless communication channel one or more parameters to define a configuration, e.g., a PHY configuration, of communications to be performed over the licensed sub-10 GHz wireless communication channel.

In some demonstrative aspects, devices 102 and/or 140 may be configured to communicate over the unlicensed sub-10 GHz wireless communication channel one or more of a subcarrier spacing, an orthogonal frequency-division multiplexing (OFDM) Fast Fourier Transform (FFT) size, a cyclic prefix size, and/or any other additional or alternative parameter to define a configuration, e.g., a PHY configuration, of communications to be performed over the licensed sub-10 GHz wireless communication channel. In one example, devices 102 and/or 140 may be restricted to communicate only a subset of the parameters over the unlicensed sub-10 GHz wireless communication channel, for example, in order to maintain low complexity.

In some demonstrative aspects, a first AP, e.g., other than a second AP that operates in a private network channel, may be configured to provide to a STA, e.g., out of band, one or more parameters for discovery of basic PHY parameters to operate on the channel, and/or any other additional or alternative parameters.

In some demonstrative aspects, the STA may be configured to scan the 2.4 GHz unlicensed band, to discover the first AP that includes in its beacon/probe response the information of the second AP in the area that operates in the private networks band, and provides its basic PHY processing parameters.

In some demonstrative aspects, the first AP and the second AP may operate over a multi-link framework, e.g., as part of an AP MLD. According to these embodiments, the second AP, e.g., which operates on the private network, may belong to the same AP MLD as at least one other AP, e.g., the first AP, which operates in an unlicensed Wi-Fi band, e.g., the 2.4/5 GHz.

For example, the discovery of the second AP may be achieved through the signaling sent by the first AP on the unlicensed sub-10 GHz wireless communication channel.

For example, basic information for the second AP and/or other APs of the AP MLD may be provided in a reduced neighbor report, which may be included as part of a beacon and/or probe response frame.

For example, complete information for the second AP and/or other APs of the AP MLD may be provided in in a multi-link element, which may be included, for example, in a beacon and/or probe response frame. In one example, the multi-link element may be included in a per-STA profile corresponding to the second AP, for example, in accordance with the IEEE 802.11be Specification and/or the IEEE 802.11ax Specification.

In some demonstrative aspects, one or more fields and/or elements, e.g., new fields/elements may be defined to signal one or more new parameters.

In some demonstrative aspects, the first AP and the second AP may not operate over a multi-link framework, e.g., the first AP and the second AP may not be implemented as part of an AP MLD. According to these embodiments, the reduced neighbor report element may be defined, for example, to provide some or all of the needed information for the basic PHY processing. In other aspects, a new additional and/or alternative element may be defined.

In some demonstrative aspects, a STA, e.g., the STA implemented by device 140, may be configured to associate, e.g., out-of-band, with the second AP, for example, utilizing the multi-link framework, e.g., in accordance with the IEEE 802.11be Specification.

In some demonstrative aspects, a STA e.g., the STA implemented by device 140, and/or an AP, e.g., the AP implemented by device 102, may be configured to utilize one or more rules for discovery and/or channel access, e.g., as described below.

For example, the STA may be forced to not transmit any probes in the private network band.

For example, the STA may be forced to not access the licensed sub-10 GHz wireless communication channel on its own, for example, in a non-trigger based (non-TB) manner, e.g., through an Enhanced Distributed Channel Access (EDCA) mechanism.

For example, the STA may be configured to access the licensed sub-10 GHz wireless communication channel only when triggered by the AP operating on the licensed sub-10 GHz wireless communication channel.

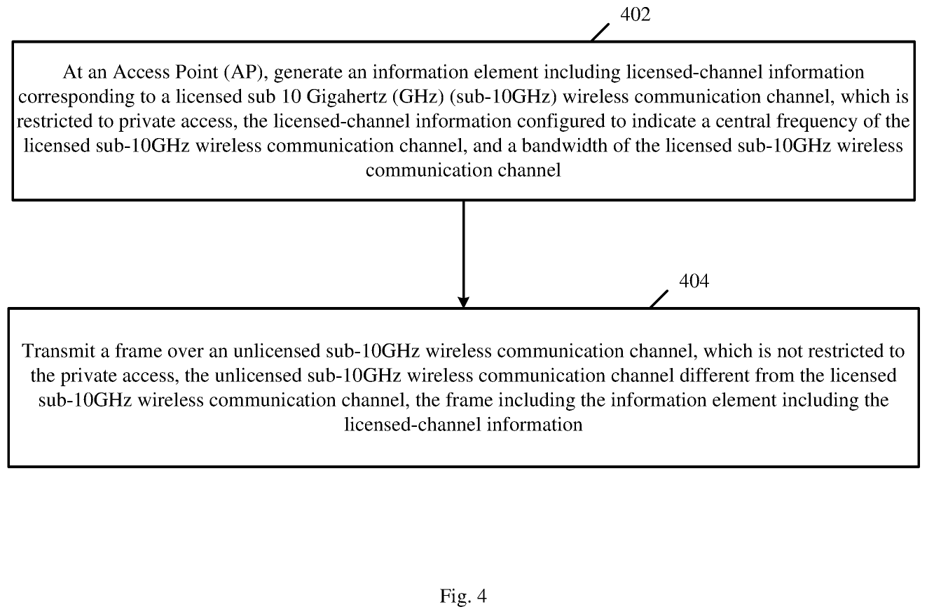

Reference is made to FIG. 4, which schematically illustrates a method of wireless communication over a licensed sub-10 GHz wireless communication channel, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include generating, at an AP, an information element including licensed-channel information corresponding to a licensed sub-10 GHz wireless communication channel, which is restricted to private access, the licensed-channel information configured to indicate a central frequency of the licensed sub-10 GHz wireless communication channel, and a bandwidth of the licensed sub-10 GHz wireless communication channel. For example, controller 124 (FIG. 1) may be configured to cause, trigger, and/or control AP 135 (FIG. 1) to generate the information element including licensed-channel information corresponding to the licensed sub-10 GHz wireless communication channel, e.g., as described above.

As indicated at block 404, the method may include transmitting a frame over an unlicensed sub-10 GHz wireless communication channel, which is not restricted to the private access, the unlicensed sub-10 GHz wireless communication channel different from the licensed sub-10 GHz wireless communication channel, the frame including the information element including the licensed-channel information. For example, controller 124 (FIG. 1) may be configured to cause, trigger, and/or control AP 135 (FIG. 1) to transmit the frame over the unlicensed sub-10 GHz wireless communication channel, e.g., as described above.

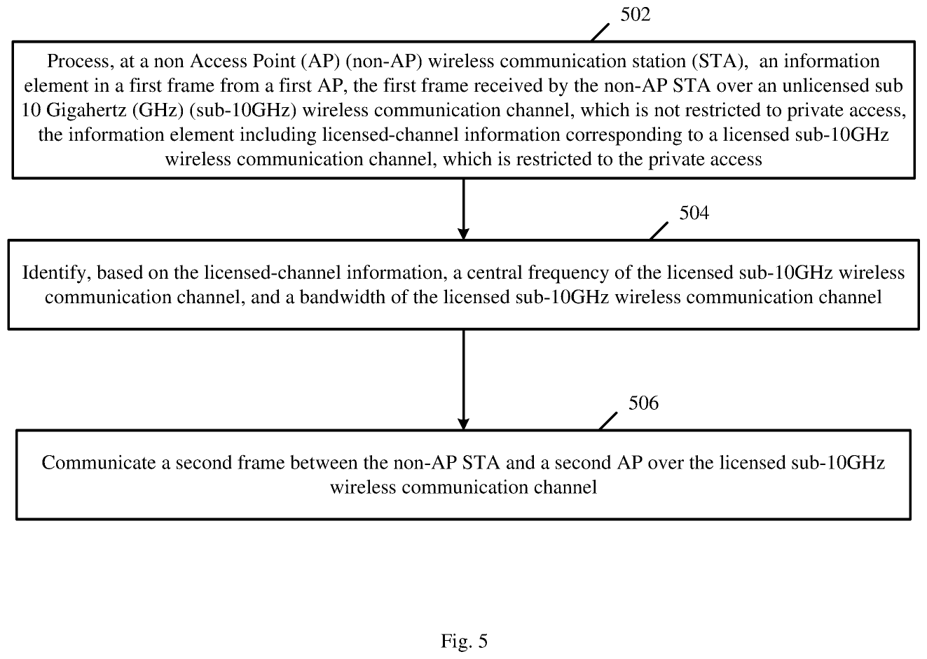

Reference is made to FIG. 5, which schematically illustrates a method of wireless communication over a licensed sub-10 GHz wireless communication channel, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include processing, at a non-AP STA, an information element in a first frame from a first AP, the first frame received by the non-AP STA over an unlicensed sub-10 GHz wireless communication channel, which is not restricted to private access, the information element including licensed-channel information corresponding to a licensed sub-10 GHz wireless communication channel, which is restricted to the private access. For example, controller 154 (FIG. 1) may be configured to cause, trigger, and/or control STA 155 (FIG. 1) to process the information element in the first frame from AP 135 (FIG. 1), the first frame received by STA 155 (FIG. 1) over the unlicensed sub-10 GHz wireless communication channel, which is not restricted to private access, e.g., as described above.

As indicated at block 504, the method may include identifying, based on the licensed-channel information, a central frequency of the licensed sub-10 GHz wireless communication channel, and a bandwidth of the licensed sub-10 GHz wireless communication channel. For example, controller 154 (FIG. 1) may be configured to cause, trigger, and/or control STA 155 (FIG. 1) to identify, based on the licensed-channel information, a central frequency of the licensed sub-10 GHz wireless communication channel, and a bandwidth of the licensed sub-10 GHz wireless communication channel, e.g., as described above.

As indicated at block 506, the method may include communicating a second frame between the non-AP STA and a second AP over the licensed sub-10 GHz wireless communication channel. For example, controller 154 (FIG. 1) may be configured to cause, trigger, and/or control STA 155 (FIG. 1) communicate a second frame between STA 155 (FIG. 1) and AP 137 (FIG. 1) over the licensed sub-10 GHz wireless communication channel, e.g., as described above.

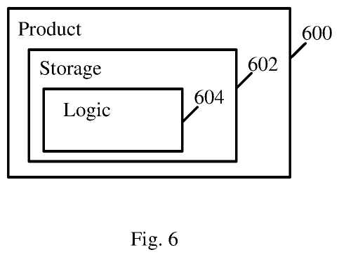

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities, and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further aspects.

Example 1 includes an apparatus comprising logic and circuitry configured to cause an Access Point (AP) to generate an information element comprising licensed-channel information corresponding to a licensed sub 10 Gigahertz (GHz) (sub-10 GHz) wireless communication channel, which is restricted to private access, the licensed-channel information configured to indicate a central frequency of the licensed sub-10 GHz wireless communication channel, and a bandwidth of the licensed sub-10 GHz wireless communication channel; and transmit a frame over an unlicensed sub-10 GHz wireless communication channel, which is not restricted to the private access, the unlicensed sub-10 GHz wireless communication channel different from the licensed sub-10 GHz wireless communication channel, the frame comprising the information element comprising the licensed-channel information.

Example 2 includes the subject matter of Example 1, and optionally, wherein the AP comprises a first AP of a plurality of APs of an AP Multi-Link Device (MLD), wherein the licensed sub-10 GHz wireless communication channel comprises wireless communication channel utilized by a second AP of the plurality of APs of the AP MLD.

Example 3 includes the subject matter of Example 2, and optionally, wherein the apparatus is configured to cause the second AP to communicate an other frame between the second AP and a non-AP STA over the licensed sub-10 GHz wireless communication channel.

Example 4 includes the subject matter of any one of Examples 1-3, and optionally, wherein the licensed-channel information is configured to indicate the central frequency of the licensed sub-10 GHz wireless communication channel based on a sum of a starting frequency and a product of an integer channel number by 1 Megahertz (MHz).

Example 5 includes the subject matter of any one of Examples 1-4, and optionally, wherein the licensed-channel information is configured to indicate the bandwidth of the licensed sub-10 GHz wireless communication channel based on an integer multiple of a basic channel frequency.

Example 6 includes the subject matter of Example 5, and optionally, wherein the basic channel frequency is 5 Megahertz (MHz), 10 MHz, 20 MHz, or 100 MHz.

Example 7 includes the subject matter of any one of Examples 1-6, and optionally, wherein the licensed-channel information is configured to indicate one or more transmit power limitations for transmission over the licensed sub-10 GHz wireless communication channel.

Example 8 includes the subject matter of any one of Examples 1-7, and optionally, wherein the licensed-channel information is configured to indicate one or more Physical layer (PHY) processing parameters for processing communication over the licensed sub-10 GHz wireless communication channel.

Example 9 includes the subject matter of any one of Examples 1-8, and optionally, wherein the frame comprises a neighbor report element comprising the information element comprising the licensed-channel information.

Example 10 includes the subject matter of any one of Examples 1-9, and optionally, wherein the frame comprises a beacon or a probe response.

Example 11 includes the subject matter of any one of Examples 1-10, and optionally, wherein the unlicensed sub-10 GHz wireless communication channel comprises an unlicensed channel in a 2.4 GHz wireless communication frequency band, or an unlicensed channel in a 5 GHz wireless communication frequency band.

Example 12 includes the subject matter of any one of Examples 1-11, and optionally, comprising at least one radio to transmit the frame over the unlicensed sub-10 GHz wireless communication channel.

Example 13 includes the subject matter of Example 12, and optionally, comprising one or more antennas connected to the radio, and a processor to execute instructions of an operating system of the AP.

Example 14 includes an apparatus comprising logic and circuitry configured to cause a non Access Point (AP) (non-AP) wireless communication station (STA) to process an information element in a first frame from a first AP, the first frame received by the non-AP STA over an unlicensed sub 10 Gigahertz (GHz) (sub-10 GHz) wireless communication channel, which is not restricted to private access, the information element comprising licensed-channel information corresponding to a licensed sub-10 GHz wireless communication channel, which is restricted to the private access; identify, based on the licensed-channel information, a central frequency of the licensed sub-10 GHz wireless communication channel, and a bandwidth of the licensed sub-10 GHz wireless communication channel; and communicate a second frame between the non-AP STA and a second AP over the licensed sub-10 GHz wireless communication channel.

Example 15 includes the subject matter of Example 14, and optionally, wherein the non-AP STA comprises a non-AP Multi-Link Device (MLD) comprising a plurality of non-AP STAs, wherein the first frame is to be received by a first non-AP STA of the plurality of non-AP STAs, and the second frame is to be communicated by a second non-AP STA of the plurality of non-AP STAs.

Example 16 includes the subject matter of Example 14 or 15, and optionally, wherein the apparatus is configured to cause the non-AP STA to, based on the licensed-channel information, determine the central frequency of the licensed sub-10 GHz wireless communication channel based on a sum of a starting frequency and a product of an integer channel number by 1 Megahertz (MHz).

Example 17 includes the subject matter of any one of Examples 14-16, and optionally, wherein the apparatus is configured to cause the non-AP STA to, based on the licensed-channel information, determine the bandwidth of the licensed sub-10 GHz wireless communication channel based on an integer multiple of a basic channel frequency.

Example 18 includes the subject matter of Example 17, and optionally, wherein the basic channel frequency is 5 Megahertz (MHz), 10 MHz, 20 MHz, or 100 MHz.

Example 19 includes the subject matter of any one of Examples 14-18, and optionally, wherein the apparatus is configured to cause the non-AP STA to, based on the licensed-channel information, determine one or more transmit power limitations for transmission over the licensed sub-10 GHz wireless communication channel.

Example 20 includes the subject matter of any one of Examples 14-19, and optionally, wherein the apparatus is configured to cause the non-AP STA to, based on the licensed-channel information, determine one or more Physical layer (PHY) processing parameters for processing communication over the licensed sub-10 GHz wireless communication channel.

Example 21 includes the subject matter of any one of Examples 14-20, and optionally, wherein the apparatus is configured to disable the non-AP STA to transmit any probe frames over the licensed sub-10 GHz wireless communication channel.

Example 22 includes the subject matter of any one of Examples 14-21, and optionally, wherein the apparatus is configured to disable the non-AP STA to access the sub-10 GHz wireless communication channel unless triggered by the second AP.

Example 23 includes the subject matter of any one of Examples 14-22, and optionally, wherein the apparatus is configured to restrict the non-AP STA to accessing the sub-10 GHz wireless communication channel for transmission only based on receipt of a trigger frame from the second AP over the licensed sub-10 GHz wireless communication channel.

Example 24 includes the subject matter of any one of Examples 14-23, and optionally, wherein the first frame comprises a neighbor report element comprising the information element comprising the licensed-channel information.

Example 25 includes the subject matter of any one of Examples 14-24, and optionally, wherein the first frame comprises a beacon or a probe response.

Example 26 includes the subject matter of any one of Examples 14-25, and optionally, wherein the unlicensed sub-10 GHz wireless communication channel comprises an unlicensed channel in a 2.4 GHz wireless communication frequency band, or an unlicensed channel in a 5 GHz wireless communication frequency band.

Example 27 includes the subject matter of any one of Examples 14-26, and optionally, comprising at least one radio to receive the first frame over the unlicensed sub-10 GHz wireless communication channel.

Example 28 includes the subject matter of Example 27, and optionally, comprising one or more antennas connected to the radio, and a processor to execute instructions of an operating system of the non-AP STA.

Example 29 comprises an apparatus comprising means for executing any of the described operations of Examples 1-28.

Example 30 comprises a product comprising one or more tangible computer-readable non-transitory storage media comprising computer-executable instructions operable to, when executed by at least one processor, enable the at least one processor to cause a computing device to perform any of the described operations of Examples 1-28.

Example 31 comprises an apparatus comprising: a memory interface; and processing circuitry configured to: perform any of the described operations of Examples 1-28.

Example 32 comprises a method comprising any of the described operations of Examples 1-28.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) to:
generate an information element comprising licensed-channel information corresponding to a licensed sub 10 Gigahertz (GHz) (sub-10 GHz) wireless communication channel, which is restricted to private access, the licensed-channel information configured to indicate a central frequency of the licensed sub-10 GHz wireless communication channel, and a bandwidth of the licensed sub-10 GHz wireless communication channel; and
transmit a frame over an unlicensed sub-10 GHz wireless communication channel, which is not restricted to the private access, the unlicensed sub-10 GHz wireless communication channel different from the licensed sub-10 GHz wireless communication channel, the frame comprising the information element comprising the licensed-channel information.

2. The apparatus of claim 1, wherein the AP comprises a first AP of a plurality of APs of an AP Multi-Link Device (MLD), wherein the licensed sub-10 GHz wireless communication channel comprises wireless communication channel utilized by a second AP of the plurality of APs of the AP MLD.

3. The apparatus of claim 2 configured to cause the second AP to communicate an other frame between the second AP and a non-AP STA over the licensed sub-10 GHz wireless communication channel.

4. The apparatus of claim 1, wherein the licensed-channel information is configured to indicate the central frequency of the licensed sub-10 GHz wireless communication channel based on a sum of a starting frequency and a product of an integer channel number by 1 Megahertz (MHz).

5. The apparatus of claim 1, wherein the licensed-channel information is configured to indicate the bandwidth of the licensed sub-10 GHz wireless communication channel based on an integer multiple of a basic channel frequency.

6. The apparatus of claim 5, wherein the basic channel frequency is 5 Megahertz (MHz), 10 MHz, 20 MHz, or 100 MHz.

7. The apparatus of claim 1, wherein the licensed-channel information is configured to indicate one or more transmit power limitations for transmission over the licensed sub-10 GHz wireless communication channel.

8. The apparatus of claim 1, wherein the licensed-channel information is configured to indicate one or more Physical layer (PHY) processing parameters for processing communication over the licensed sub-10 GHz wireless communication channel.

9. The apparatus of claim 1, wherein the frame comprises a neighbor report element comprising the information element comprising the licensed-channel information.

10. The apparatus of claim 1, wherein the frame comprises a beacon or a probe response.

11. The apparatus of claim 1, wherein the unlicensed sub-10 GHz wireless communication channel comprises an unlicensed channel in a 2.4 GHz wireless communication frequency band, or an unlicensed channel in a 5 GHz wireless communication frequency band.

12. The apparatus of claim 1 comprising at least one radio to transmit the frame over the unlicensed sub-10 GHz wireless communication channel.

13. The apparatus of claim 12 comprising one or more antennas connected to the radio, and a processor to execute instructions of an operating system of the AP.

14. A product comprising one or more tangible computer-readable non-transitory storage media comprising computer-executable instructions operable to, when executed by at least one processor, enable the at least one processor to cause an Access Point (AP) to:
generate an information element comprising licensed-channel information corresponding to a licensed sub 10 Gigahertz (GHz) (sub-10 GHz) wireless communication channel, which is restricted to private access, the licensed-channel information configured to indicate a central frequency of the licensed sub-10 GHz wireless communication channel, and a bandwidth of the licensed sub-10 GHz wireless communication channel; and
transmit a frame over an unlicensed sub-10 GHz wireless communication channel, which is not restricted to the private access, the unlicensed sub-10 GHz wireless communication channel different from the licensed sub-10 GHz wireless communication channel, the frame comprising the information element comprising the licensed-channel information.

15. The product of claim 14, wherein the AP comprises a first AP of a plurality of APs of an AP Multi-Link Device (MLD), wherein the licensed sub-10 GHz wireless communication channel comprises wireless communication channel utilized by a second AP of the plurality of APs of the AP MLD.

16. An apparatus comprising logic and circuitry configured to cause a non Access Point (AP) (non-AP) wireless communication station (STA) to:
process an information element in a first frame from a first AP, the first frame received by the non-AP STA over an unlicensed sub 10 Gigahertz (GHz) (sub-10 GHz) wireless communication channel, which is not restricted to private access, the information element comprising licensed-channel information corresponding to a licensed sub-10 GHz wireless communication channel, which is restricted to the private access;
identify, based on the licensed-channel information, a central frequency of the licensed sub-10 GHz wireless communication channel, and a bandwidth of the licensed sub-10 GHz wireless communication channel; and
communicate a second frame between the non-AP STA and a second AP over the licensed sub-10 GHz wireless communication channel.

17. The apparatus of claim 16, wherein the non-AP STA comprises a non-AP Multi-Link Device (MLD) comprising a plurality of non-AP STAs, wherein the first frame is to be received by a first non-AP STA of the plurality of non-AP STAs, and the second frame is to be communicated by a second non-AP STA of the plurality of non-AP STAs.

18. The apparatus claim 16 configured to disable the non-AP STA to transmit any probe frames over the licensed sub-10 GHz wireless communication channel.

19. The apparatus claim 16 configured to disable the non-AP STA to access the sub-10 GHz wireless communication channel unless triggered by the second AP.

20. The apparatus claim 16 configured to restrict the non-AP STA to accessing the sub-10 GHz wireless communication channel for transmission only based on receipt of a trigger frame from the second AP over the licensed sub-10 GHz wireless communication channel.

21. The apparatus of claim 16, wherein the unlicensed sub-10 GHz wireless communication channel comprises an unlicensed channel in a 2.4 GHz wireless communication frequency band, or an unlicensed channel in a 5 GHz wireless communication frequency band.

22. The apparatus of claim 16 comprising at least one radio to receive the first frame over the unlicensed sub-10 GHz wireless communication channel.

23. The apparatus of claim 22 comprising one or more antennas connected to the radio, and a processor to execute instructions of an operating system of the non-AP STA.

24. An apparatus comprising:
means for causing a non Access Point (AP) (non-AP) wireless communication station (STA) to process an information element in a first frame from a first AP, the first frame received by the non-AP STA over an unlicensed sub 10 Gigahertz (GHz) (sub-10 GHz) wireless communication channel, which is not restricted to private access, the information element comprising licensed-channel information corresponding to a licensed sub-10 GHz wireless communication channel, which is restricted to the private access;
means for identifying, based on the licensed-channel information, a central frequency of the licensed sub-10 GHz wireless communication channel, and a bandwidth of the licensed sub-10 GHz wireless communication channel; and
means for causing the non-AP STA to communicate a second frame between the non-AP STA and a second AP over the licensed sub-10 GHz wireless communication channel.

25. The apparatus claim 24 comprising means for disabling the non-AP STA to access the sub-10 GHz wireless communication channel unless triggered by the second AP.
